(19) United States
(12) Patent Application Publication
(10) Pub. No.: US 2015/0263368 A1
(43) Pub. Date: Sep. 17, 2015

(54) POWER GENERATION SYSTEM AND METHOD OF OPERATING POWER GENERATION SYSTEM

(71) Applicant: MITSUBISHI HEAVY INDUSTRIES, LTD., Tokyo (JP)

(72) Inventors: Yukimasa Nakamoto, Tokyo (JP); Kazunori Fujita, Tokyo (JP); Hiroyuki Ozawa, Tokyo (JP)

(21) Appl. No.: 14/435,327

(22) PCT Filed: Nov. 15, 2013
(86) PCT No.: PCT/JP2013/080925

§ 371 Date: Apr. 13, 2015

(30) Foreign Application Priority Data
Nov. 22, 2012 (JP) 2012-256906

(51) Int. Cl. H01M 8/06; F02C 6/18; H01M 8/04; F02C 3/22

(52) U.S. Cl. CPC H01M 8/0662; F02C 3/22; F02C 6/18; H01M 8/04022; H01M 2008/1293

(57) ABSTRACT

In a power generation system and a method of operating a power generation system, provided are a gas turbine (11) including a compressor (21) and a combustor (22), a fuel cell (13), an exhausted fuel gas supply line (45) that supplies an exhausted fuel gas discharged from the fuel cell (13) to the gas turbine (11), an exhausted fuel gas discharge line (72) connected to the exhausted fuel gas supply line (45), heating means (70) that burns the exhausted fuel gas supplied through the exhausted fuel gas discharge line (72) to heat an object to be heated, and a control unit (control device) (62) that controls a supply destination of the exhausted fuel gas.

### FIELD

The present invention relates to a power generation system in which a solid oxide fuel cell, a gas turbine, and a steam turbine are combined, and a method of operating a power generation system.

### BACKGROUND

A solid oxide fuel cell (hereinafter, SOFC) is well known as a highly efficient fuel cell having various uses. The operation temperature of the SOFC is set to a high temperature in order to enhance ionic conductivity. Therefore, compressed air emitted from a compressor of a gas turbine can be used as air (oxidant) to be supplied to an cathode side. Further, a high-temperature exhausted fuel gas discharged from the SOFC can be used as a fuel of a combustor of the gas turbine.

Therefore, for example, as described in Patent Literature 1 below, as a power generation system that can achieve high-efficient power generation, various proposals of combinations of the SOFC, the gas turbine, and the steam turbine have been given. In the combined systems described in Patent Literature 1, the gas turbine includes a compressor that compresses air and supplies the air to the SOFC, and a combustor that generates a combustion gas from the exhausted fuel gas discharged from the SOFC and the compressed air.

### CITATION LIST

### Patent Literature

Patent Literature 1: Japanese Patent Application Laid-open No. 2009-205932

### SUMMARY

### Technical Problem

In the above-described conventional power generation system, at startup of the SOFC, components of the exhausted fuel gas discharged from the SOFC during a certain period from start of supply of a fuel gas to the SOFC are unstable. Therefore, during the period, it is difficult to supply the exhausted fuel gas to the combustor. Further, in the power generation system, a necessary calorie of the fuel varies depending on the output of the gas turbine. When the necessary calorie of the fuel varies, the amount of the exhausted fuel gas to be put in varies. Therefore, the exhausted fuel gasses that cannot be supplied to the combustor are caused, and the exhausted fuel gas cannot be efficiently used.

The present invention solves the above-described problems, and an objective is to provide a power generation system and a method of operating a power generation system that can efficiently use an exhausted fuel gas discharged from a fuel cell.

### Solution to Problem

According to an aspect of the present invention, a power generation system comprises: a gas turbine including a compressor and a combustor; a fuel cell; an exhausted fuel gas supply line configured to supply an exhausted fuel gas discharged from the fuel cell to the gas turbine; an exhausted fuel gas discharge line connected to the exhausted fuel gas supply line; a heating unit configured to burn the exhausted fuel gas supplied through the exhausted fuel gas discharge line to heat an object to be heated; and a control unit configured to control a supply destination of the exhausted fuel gas discharged from the fuel cell.

Therefore, with the heating means, the exhausted fuel gas not to be supplied to the gas turbine can be fueled by the heating means. Accordingly, the exhausted fuel gas discharged from the fuel cell can be efficiently used.

Advantageously, the power generation system further comprises a heat exchanger configured to recover heat included in a flue gas discharged from the gas turbine. The heating unit includes a flue gas heating unit that burns the exhausted fuel gas to heat the flue gas to be supplied to the heat exchanger.

Therefore, the amount of heat that can be recovered by the heat exchanger can be increased. Accordingly, the exhausted fuel gas discharged from the fuel cell can be efficiently used.

Advantageously, in the power generation system, the heating unit includes a steam generation unit that burns the exhausted fuel gas to generate steam to be supplied to a fuel gas to be supplied to the fuel cell.

Therefore, the exhausted fuel gas can be burned and the steam can be generated. Further, heat included in the steam can be used for power generation. Accordingly, the exhausted fuel gas discharged from the fuel cell can be efficiently used.

Advantageously, in the power generation system, the heating unit includes an air heating unit that burns the exhausted fuel gas to heat air to be supplied to the fuel cell.

Therefore, the exhausted fuel gas can be burned and the air can be heated. Further, heat included in the heated air can be used for power generation. Accordingly, the exhausted fuel gas discharged from the fuel cell can be efficiently used.

Advantageously, in the power generation system, the heating unit includes a fuel gas heating unit that burns the exhausted fuel gas to heat a fuel gas to be supplied to the fuel cell.

Therefore, the exhausted fuel gas can be burned and the fuel can be heated. Further, heat included in the heated air can be used for power generation. Accordingly, the exhausted fuel gas discharged from the fuel cell can be efficiently used.

Advantageously, the power generation system further comprises a state detection unit configured to detect a state of the exhausted fuel gas at an upper stream side of the exhausted fuel gas discharge line. When it is determined that the state of the exhausted fuel gas is stabilized, based on a result detected in the state detection unit, supply of the exhausted fuel gas to the gas turbine is started.

Therefore, the exhausted fuel gas in the stable state can be supplied to the gas turbine. Accordingly, the gas turbine can be efficiently operated, and the control can be simplified. Further, the exhausted fuel gas in an unstable state can be used in the heating means. Therefore, the exhausted fuel gas can be effectively used.

Advantageously, the power generation system comprises a flow rate detection unit configured to detect a flow rate of the exhausted fuel gas to be supplied from the fuel cell to the exhausted fuel gas supply line and the exhausted fuel gas discharge line. The control unit controls a flow rate of the exhausted fuel gas to be supplied to the exhausted fuel gas supply line and a flow rate of the exhausted fuel gas to be supplied to the exhausted fuel gas discharge line, based on a detection result of the flow rate detection unit.

Therefore, the exhausted fuel gas not to be supplied to the gas turbine can be supplied to the heating means. Accordingly, the excess exhausted fuel gas can be prevented from being supplied to the gas turbine, the gas turbine can be efficiently operated, and the control can be simplified. Further, the exhausted fuel gas not to be supplied to the gas turbine can be used in the heating means. Therefore, the exhausted fuel gas can be effectively used.

According to another aspect of the present invention, a method of operating a power generation system including a gas turbine including a compressor and a combustor, a fuel cell, and heating unit that burns an exhausted fuel gas to heat an object to be heated, comprises: detecting a state of the exhausted fuel gas discharged from the fuel cell toward the gas turbine; determining whether there is the exhausted fuel gas not to be supplied to the gas turbine, based on the detected state of the exhausted fuel gas; and supplying the exhausted fuel gas to the heating unit when it is determined that there is the exhausted fuel gas not to be supplied to the gas turbine.

Therefore, the exhausted fuel gas not to be supplied to the gas turbine can be fueled by the heating means. Accordingly, the exhausted fuel gas discharged from the fuel cell can be efficiently used.

### Advantageous Effects of Invention

According to the power generation system and the method of operating a power generation system of the present invention, the exhausted fuel gas not to be supplied to the gas turbine is heated by the heating means, and can be used in units of the power generation system. Accordingly, the exhausted fuel gas discharged from the fuel cell can be efficiently used.

### BRIEF DESCRIPTION OF DRAWINGS

FIG. 1 is a schematic configuration diagram illustrating a power generation system of the present embodiment.

FIG. 2 is a schematic configuration diagram illustrating heating means and an exhausted fuel gas discharge line in the power generation system according to an embodiment of the present invention.

FIG. 3 is a schematic configuration diagram illustrating a bath heater of a fuel gas heating unit.

FIG. 4 is a flowchart illustrating an example of a drive operation of the power generation system of the present embodiment.

FIG. 5 is a time chart illustrating timing of operations of valves that control a flow of an exhausted fuel gas of the power generation system of the present embodiment.

FIG. 6 is a flowchart illustrating an example of a drive operation of the power generation system of the present embodiment.

### DESCRIPTION OF EMBODIMENTS

Hereinafter, favorable embodiments of a power generation system and a method of generating a power generation system according to the present invention will be described in detail with reference to the appended drawings. Note that the present invention is not limited by these embodiments, and includes ones configured from combined embodiments when there is a plurality of embodiments.

### EMBODIMENTS

A power generation system of the present embodiment is a Triple Combined Cycle (registered trademark) that is a combination of a solid oxide fuel cell (hereinafter, referred to as SOFC), a gas turbine, and a steam turbine. The Triple Combined Cycle can generate power in three stages of the SOFC, the gas turbine, and the steam turbine by installing the SOFC at an upper stream side of gas turbine combined cycle power generation (GTCC), and thus can realize extremely high power generation efficiency. Note that, in the description below, a solid oxide fuel cell is applied as the fuel cell of the present invention and description will be given. However, the fuel cell of the present invention is not limited to the fuel cell of this form.

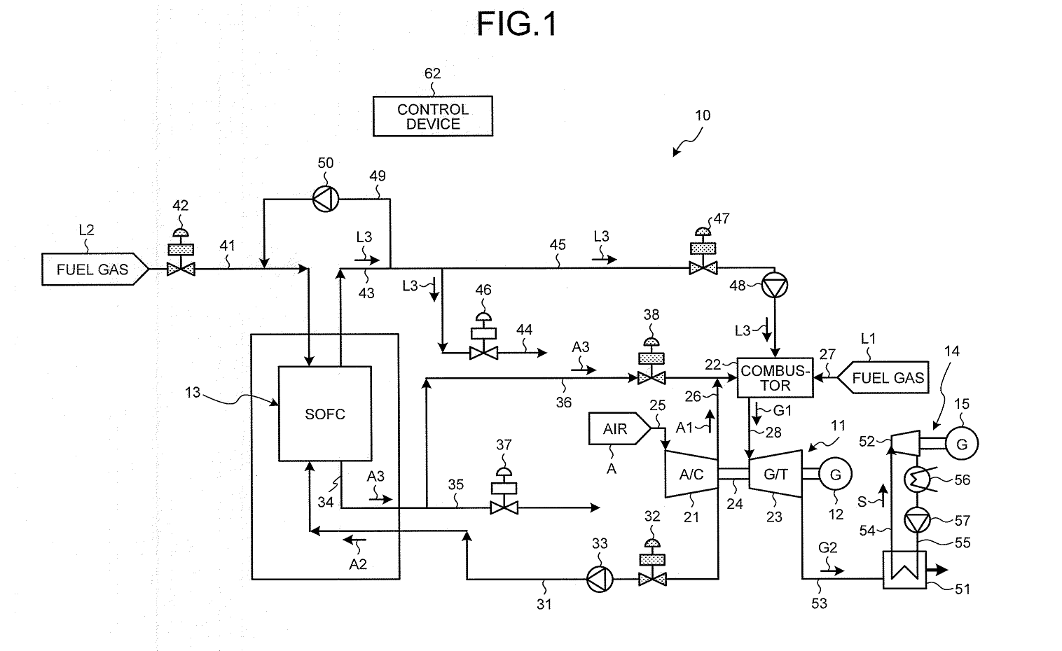

FIG. 1 is a schematic configuration diagram illustrating a power generation system of the present embodiment. In the present embodiment, as illustrated in FIG. 1, a power generation system 10 includes a gas turbine 11, a generator 12, an SOFC 13, a steam turbine 14, and a generator 15. The power generation system 10 is configured to obtain high power generation efficiency, by combining power generation by the gas turbine 11, power generation by the SOFC 13, and power generation of the steam turbine 14. Further, the power generation system 10 includes a control device 62. The control device 62 controls operations of units of the power generation system 10, based on input setting, an input instruction, a result detected in a detection unit, and so on.

The gas turbine 11 includes a compressor 21, a combustor 22, and a turbine 23, and the compressor 21 and the turbine 23 are coupled with a rotation axis 24 in an integrally rotatable manner. The compressor 21 compresses air A taken in from an air taking-in line 25. The combustor 22 mixes and burns compressed air A1 supplied from the compressor 21 through a first compressed air supply line 26, and a fuel gas L1 supplied through a first fuel gas supply line 27. The turbine 23 is rotated by a combustion gas G1 supplied from the combustor 22 through a flue gas supply line 28. Note that, although not illustrated, the compressed air A1 compressed in the compressor 21 is supplied to the turbine 23 through a casing, and the turbine 23 cools a blade and so on using the compressed air A1 as cooling air. The generator 12 is provided on the same axis as the turbine 23, and can generate power by rotation of the turbine 23. Note that, here, a liquefied natural gas (LNG) is used as the fuel gas L1 supplied to the combustor 22.

The SOFC 13 reacts and generates power at a predetermined operation temperature by supply of a high-temperature fuel gas as a reductant, and high-temperature air (oxidized gas) as an oxidant. The SOFC 13 is configured such that an cathode, a solid electrolyte, and a anode are housed in a pressure container. The SOFC 13 generates the power by supply of a part of compressed air A2 compressed in the compressor 21 to the cathode, and a fuel gas L2 to the anode. Note that, here, as the fuel gas L2 supplied to the SOFC 13, a liquefied natural gas (LNG), hydrogen (H₂), a hydrocarbon gas such as carbon monoxide (CO) or methane (CH₄), a gas manufactured in a gasification facility of a carbonaceous material such as coal is used, for example. Further, the oxidized gas supplied to the SOFC 13 is a gas containing approximately 15% to 30% of oxygen, and typically, air is favorable. However, a mixed gas of a burned flue gas and air, a mixed gas of oxygen and air, and so on, other than air, can be used (hereinafter, the oxidized gas supplied to the SOFC 13 is referred to as air).

A second compressed air supply line 31 diverging from the first compressed air supply line 26 is coupled with the SOFC 13, and a part of the compressed air A2 compressed in the compressor 21 can be supplied to an introduction part of the cathode. The second compressed air supply line 31 includes a control valve 32 that can adjust the amount of air to be supplied and a blower (booster) 33 that can increase a pressure of the compressed air A2 along a flow direction of the compressed air A2. The control valve 32 is provided at an upper stream side of the flow direction of the compressed air A2, and the blower 33 is provided at a downstream side of the control valve 32, in the second compressed air supply line 31. An exhausted air line 34 that discharges compressed air A3 (exhausted air) used in the cathode is coupled with the SOFC 13. The exhausted air line 34 diverges into a discharge line 35 that discharges the compressed air A3 used in the cathode to an outside, and a compressed air circulating line 36 coupled with the combustor 22. The discharge line 35 includes a control valve 37 that can adjust the amount of air to be discharged, and the compressed air circulating line 36 includes a control valve 38 that can adjust the amount of circulating air.

Further, the SOFC 13 includes a second fuel gas supply line 41 that supplies the fuel gas L2 to an introduction part of the anode. The second fuel gas supply line 41 includes a control valve 42 that can adjust the amount of the fuel gas to be supplied. An exhausted fuel line 43 that discharges an exhausted fuel gas L3 used in the anode is coupled with the SOFC 13. The exhausted fuel line 43 diverges into a discharge line 44 that discharges the exhausted fuel gas L3 to an outside, and an exhausted fuel gas supply line 45 coupled with the combustor 22. The discharge line 44 includes a control valve 46 that can adjust the amount of the fuel gas to be discharged, and the exhausted fuel gas supply line 45 includes a control valve 47 that can adjust the amount of the fuel gas to be supplied, and a blower 48 that can increase a pressure of the exhausted fuel gas L3 along a flow direction of the exhausted fuel gas L3. The control valve 47 is provided at an upper stream side of the flow direction of the exhausted fuel gas L3, and the blower 48 is provided at a downstream side of the control valve 47, in the exhausted fuel gas supply line 45.

Further, a fuel gas recirculating line 49 that couples the exhausted fuel line 43 and the second fuel gas supply line 41 is provided in the SOFC 13. The fuel gas recirculating line 49 includes a recirculating blower 50 that allows the exhausted fuel gas L3 in the exhausted fuel line 43 to recirculate in the second fuel gas supply line 41.

In the steam turbine 14, a turbine 52 is rotated by steam generated in an exhausted heat recovery boiler (HRSG) 51. A flue gas line 53 from the gas turbine 11 (turbine 23) is coupled with the exhausted heat recovery boiler 51, and the exhausted heat recovery boiler 51 performs heat exchange between a feed water and a high-temperature flue gas G2 to generate steam S. A steam supply line 54 and a feed water line 55 are provided between the steam turbine 14 (turbine 52) and the exhausted heat recovery boiler 51. The feed water line 55 includes a condenser 56 and a feed water pump 57. The generator 15 is provided on the same axis as the turbine 52, and can generate power by rotating of the turbine 52. Note that the flue gas G2 from which heat is recovered in the exhausted heat recovery boiler 51 is released into the air after toxic substances are removed.

Here, an operation of the power generation system 10 of the present embodiment will be described. When the power generation system 10 is started, the gas turbine 11, the steam turbine 14, and the SOFC 13 are started in the order of the description.

First, in the gas turbine 11, the compressor 21 compresses the air A, the combustor 22 mixes and burns the compressed air A1 and the fuel gas L1, and the generator 12 starts to generate the power by rotation of the turbine 23 by the combustion gas G1. Next, in the steam turbine 14, the turbine 52 is rotated by the steam S generated by the exhausted heat recovery boiler 51, and the generator 15 starts to generate the power, accordingly.

Following that, to start the SOFC 13, the compressed air A2 is supplied from the compressor 21 and pressurization of the SOFC 13 is started, and heating is started. The control valve 32 is opened by a predetermined degree of opening in a state where the control valve 37 of the discharge line 35 and the control valve 38 of the compressed air circulating line 36 are closed, and the blower 33 of the second compressed air supply line 31 is stopped. Then, a part of the compressed air A2 compressed in the compressor 21 is supplied through the second compressed air supply line 31 to the SOFC 13 side. Accordingly, the pressure of the SOFC 13 side is increased by supply of the compressed air A2.

Meanwhile, at the anode side of the SOFC 13, the fuel gas L2 is supplied and pressurization is started. The control valve 42 of the second fuel gas supply line 41 is opened in a state where the control valve 46 of the discharge line 44 and the control valve 47 of the exhausted fuel gas supply line 45 are closed, and the blower 48 is stopped, and the recirculating blower 50 of the fuel gas recirculating line 49 is driven. Then, the fuel gas L2 is supplied through the second fuel gas supply line 41 to the SOFC 13 side, and the exhausted fuel gas L3 recirculates in the fuel gas recirculating line 49. Accordingly, the pressure of the anode side of the SOFC 13 is increased by supply of the fuel gas L2.

Then, when the pressure of the cathode side of the SOFC 13 becomes an output pressure of the compressor 21, the control valve 32 is fully opened, and the blower 33 is driven. At the same time, the control valve 37 is opened, and the exhausted air A3 from the SOFC 13 is discharged through the discharge line 35. Then, the compressed air A2 is supplied to the SOFC 13 side by the blower 33. At the same time, the control valve 46 is opened, and the exhausted fuel gas L3 from the SOFC 13 is discharged through the discharge line 44. Then, when the pressure at the cathode side and the pressure at the anode side, in the SOFC 13, reach a target pressure, the pressurization of the SOFC 13 is completed.

Following that, when a reaction (power generation) of the SOFC 13 is stabilized, and the compressed air A3 and the components of the exhausted fuel gas L3 are stabilized, the control valve 38 is opened while the control valve 37 is closed. Then, the compressed air A3 from the SOFC 13 is supplied through the compressed air circulating line 36 to the combustor 22. Further, the control valve 47 is opened and the blower 48 is driven while the control valve 46 is closed. Then, the exhausted fuel gas L3 from the SOFC 13 is supplied through the exhausted fuel gas supply line 45 to the combustor 22. At this time, the amount of the fuel gas L1 supplied through the first fuel gas supply line 27 to the combustor 22 is decreased.

Here, all of the power generation in the generator 12 by driving of the gas turbine 11, the power generation in the SOFC 13, and the power generation in the generator 15 by driving of the steam turbine 14 are performed, whereby the power generation system 10 is steadily operated.

By the way, a typically power generation system discharges the exhausted fuel gas, which is not supplied to the gas turbine 11, that is, not burned in the combustor 22, through the discharge line 44 by opening the control valve 46. Such an exhausted fuel gas is an exhausted fuel gas, a state (components) of which is (are) not stable after the SOFC 13 is started, or an exhausted fuel gas discharged from the SOFC 13, exceeding a supply amount to the gas turbine 11, for example. Since being discharged through the discharge line 44, the exhausted fuel gas cannot be effectively used.

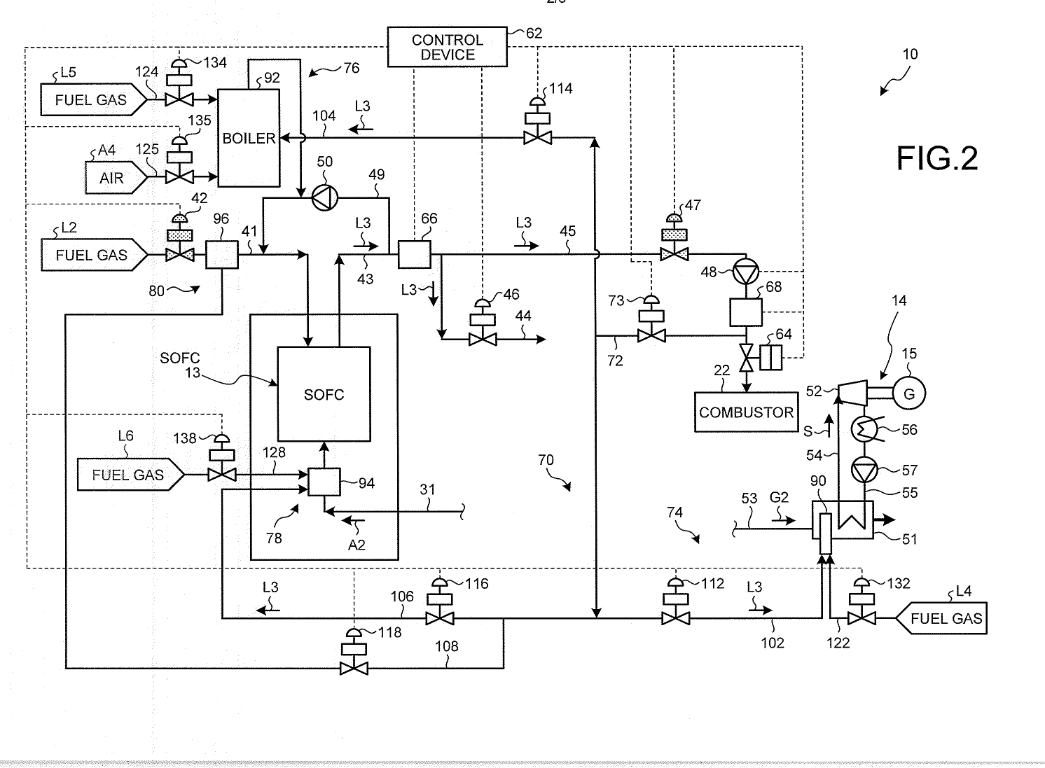

Therefore, in the power generation system 10 of the present embodiment, as illustrated in FIG. 2, heating means 70 that burns the exhausted fuel gas not to be supplied to the gas turbine 11 to heat the units of the power generation system 10 is provided. The heating means 70 includes an exhausted fuel gas discharge line 72, a control valve 73, a flue gas heating unit 74, a steam generation unit 76, an air heating unit 78, and a fuel gas heating unit 80.

That is, the power generation system 10 includes the heating means 70 that burns the exhausted fuel gas L3 not to be supplied to the gas turbine 11, and heats at least one of the flue gas, the steam, the fuel gas, and the air flowing in the power generation system 10. Accordingly, the power generation system 10 can effectively use a combustion calorific value (calorie) included in the exhausted fuel gas L3 discharged through the discharge line 44, and the exhausted fuel gas discharged from the SOFC 13 can be efficiently used.

Hereinafter, the heating means 70 and units of the exhausted fuel gas discharge line 72 will be described with reference to FIG. 2. One end portion of the exhausted fuel gas discharge line 72 is connected between the blower 48 and the combustor 22 of the exhausted fuel gas supply line 45. The other end portion of the exhausted fuel gas discharge line 72 diverges into a plurality of lines, and the lines are connected to a first diverging line 102 of the flue gas heating unit 74, a second diverging line 104 of the steam generation unit 76, a third diverging line 106 of the air heating unit 78, and a fourth diverging line 108 of the fuel gas heating unit 80, respectively. The exhausted fuel gas discharge line 72 supplies the exhausted fuel gas L3 supplied through the exhausted fuel gas supply line 45 to the diverging lines, respectively.

The control valve 73 is installed at the exhausted fuel gas discharge line 72. The control valve 73 switches circulation of the exhausted fuel gas L3 in the exhausted fuel gas discharge line 72 by switching open/close, and controls the flow rate of the exhausted fuel gas L3 flowing in the exhausted fuel gas discharge line 72 by adjusting the degree of opening.

The flue gas heating unit 74 includes a duct burner 90, a first diverging line 102, a first control valve 112, a third fuel gas supply line 122, and a control valve 132. The duct burner 90 is arranged in the exhausted heat recovery boiler 51. The duct burner 90 heats the flue gas G2 in the exhausted heat recovery boiler 51 by burning the supplied fuel. Note that the duct burner 90 may be provided at the flue gas line 53 at the upper stream side of the exhausted heat recovery boiler 51.

One end portion of the first diverging line 102 is connected to the exhausted fuel gas discharge line 72, and the other end portion is connected to the duct burner 90. The first control valve 112 is installed at the first diverging line 102. The first control valve 112 switches the circulation of the exhausted fuel gas L3 in the first diverging line 102 by switching open/close, and controls the flow rate of the exhausted fuel gas L3 flowing in the first diverging line 102 by adjusting the degree of opening. The third fuel gas supply line 122 is connected to the duct burner 90, and supplies a fuel gas L4 to the duct burner 90. The control valve 132 is installed at the third fuel gas supply line 122, and adjusts the amount of the fuel gas L4 to be supplied to the duct burner 90 by adjusting at least one of the open/close and the degree of opening.

The flue gas heating unit 74 heats the flue gas G2 by burning the exhausted fuel gas L3 supplied through the first diverging line 102 and the fuel gas L4 supplied through the third fuel gas supply line 122 by the duct burner 90. Accordingly, the temperature of the flue gas G2 in the exhausted heat recovery boiler 51 can be further increased, and a larger amount of heat can be recovered in the exhausted heat recovery boiler 51. Further, the flue gas heating unit 74 can heat the flue gas G2 with the calorie included in the exhausted fuel gas L3 by burning the exhausted fuel gas L3 supplied through the first diverging line 102. Accordingly, the calorie included in the exhausted fuel gas L3 can be effectively used.

The steam generation unit 76 includes a boiler 92, the second diverging line 104, a second control valve 114, a fourth fuel gas supply line 124, an air supply line 125, and control valves 134 and 135. The boiler 92 is a steam generator that generates the steam using the heat generated by burning the supplied fuel, and supplies the generated steam to the fuel gas recirculating line 49. The boiler 92 of the present embodiment has a function of so-called a startup boiler used for startup of the SOFC 13. Note that the boiler 92 may be connected to another device of the power generation system 10, and supply the steam to the connected device.

One end portion of the second diverging line 104 is connected to the exhausted fuel gas discharge line 72, and the other end portion is connected to the boiler 92. The second control valve 114 is installed at the second diverging line 104. The second control valve 114 switches the circulation of the exhausted fuel gas L3 in the second diverging line 104 by switching the open/close, and controls the flow rate of the exhausted fuel gas L3 flowing in the second diverging line 104 by adjusting the degree of opening. The fourth fuel gas supply line 124 is connected to the boiler 92, and supplies a fuel gas L5 to the boiler 92. The air supply line 125 is connected to the boiler 92, and supplies air A4 to the boiler 92. The control valve 134 is installed at the fourth fuel gas supply line 124, and adjusts the amount of the fuel gas L5 to be supplied to the boiler 92 by adjusting at least one of the open/close and the degree of opening. The control valve 135 is installed at the air supply line 125, and adjusts the amount of the air A4 to be supplied to the boiler 92 by adjusting at least one of the open/close and the degree of opening.

The steam generation unit 76 supplies the exhausted fuel gas L3 supplied through the second diverging line 104 and the fuel gas L5 supplied through the fourth fuel gas supply line 124 to the boiler 92 together with the air A4 supplied through the air supply line 125, and generates the steam by burning the exhausted fuel gas L3 and the fuel gas L5 in the boiler 92. Accordingly, the steam generation unit 76 can generate, in the boiler 92, the steam necessary in the power generation system 10, and supply the steam to the units. Further, the steam generation unit 76 can use the calorie included in the exhausted fuel gas L3 as heat for generation of the steam by burning the exhausted fuel gas L3 supplied through the second diverging line 104. Accordingly, the calorie included in the exhausted fuel gas L3 can be effectively used.

The air heating unit 78 includes an air temperature raising burner 94, the third diverging line 106, a third control valve 116, a fifth fuel gas supply line 128, and a control valve 138. The air temperature raising burner 94 is arranged at the second compressed air supply line 31. The air temperature raising burner 94 heats the compressed air A2 in the second compressed air supply line 31 by burning the supplied fuel. The air heating unit 78 can use a burner including an ignition source that ignites and fuels the exhausted fuel gas L3, or a combustion catalyst that burns the exhausted fuel gas L3 by a reaction such as oxidation, as the air temperature raising burner 94 that burns the exhausted fuel gas L3. It is favorable for the air heating unit 78 to connect the third diverging line 106 with lines of an outlet of the recirculating blower 50 and of an outlet of the blower 48. Accordingly, the air heating unit 78 can supply the exhausted fuel gas L3 with a higher pressure to the air temperature raising burner 94.

One end portion of the third diverging line 106 is connected to the exhausted fuel gas discharge line 72, and the other end portion is connected to the air temperature raising burner 94. The third control valve 116 is installed at the third diverging line 106. The third control valve 116 switches the circulation of the exhausted fuel gas L3 of the third diverging line 106 by switching the open/close, and controls the flow rate of the exhausted fuel gas L3 flowing in the third diverging line 106 by adjusting the degree of opening. The fifth fuel gas supply line 128 is connected to the air temperature raising burner 94, and supplies a fuel gas L6 to the air temperature raising burner 94. The control valve 138 is installed at the fifth fuel gas supply line 128, and adjusts the amount of the fuel gas L6 to be supplied to the air temperature raising burner 94 by adjusting at least one of the open/close and the degree of opening.

The air heating unit 78 heats the compressed air A2 by burning the exhausted fuel gas L3 supplied through the third diverging line 106 and the fuel gas L6 supplied through the fifth fuel gas supply line 128 by the air temperature raising burner 94. Accordingly, the air heating unit 78 can further increase the temperature of the compressed air A2 to be supplied to the SOFC 13. Further, the compressed air A2 supplied to the SOFC 13 is supplied to the gas turbine 11, as exhausted air. Accordingly, the heat that has heated the compressed air A2 in the air heating unit 78 can be recovered in the gas turbine 11 or in the exhausted heat recovery boiler 51. Accordingly, the calorie included in the exhausted fuel gas L3 can be effectively used.

The fuel gas heating unit 80 includes a bath heater 96, the fourth diverging line 108, a fourth control valve 118, the second fuel gas supply line 41, and the control valve 42. The bath heater 96 is arranged at the second fuel gas supply line 41. The bath heater 96 heats the fuel gas L2 in the second fuel gas supply line 41 by burning the supplied exhausted fuel gas.

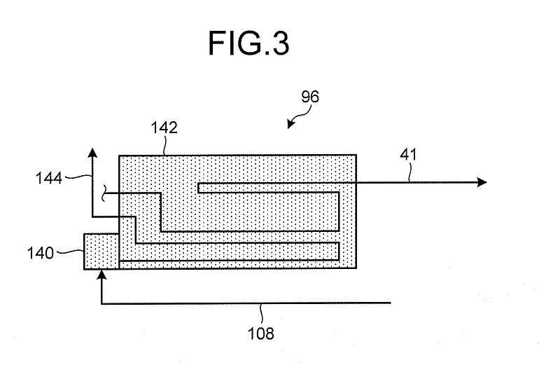

Here, FIG. 3 is a schematic configuration diagram illustrating a bath heater of a fuel gas heating unit. The bath heater 96 includes a combustor 140, a container 142, and combustion gas piping 144, as illustrated in FIG. 3. Further, the combustor 140 is connected with the fourth diverging line 108 and the combustion gas piping 144. The combustor 140 supplies a combustion gas generated by burning the exhausted fuel gas L3 supplied through the fourth diverging line 108, to the combustion gas piping 144. The container 142 is a box, an interior of which is filled with a heat medium such as water. The second fuel gas supply line 41 and the combustion gas piping 144 are arranged in the interior of the container 142, which is filled with the heat medium. One end portion of the combustion gas piping 144 is connected to the combustor 140, and the other end portion is opened. A portion between both ends of the combustion gas piping 144 is arranged in the interior of the container 142.

In the bath heater 96, the combustion gas that is the exhausted fuel gas burned and generated in the combustor 140 flows in the combustion gas piping 144. Accordingly, the combustion gas flows in the interior of the container 142. In the bath heater 96, the heat medium is heated by the combustion gas flowing in the combustion gas piping 144, and the heated heat medium heats the fuel gas flowing in the second fuel gas supply line 41. In this way, the bath heater 96 transmits the heat of the combustion gas to the fuel gas through the heat medium, thereby to heat the fuel gas. The bath heater 96 can heat the fuel gas while preventing the fuel gas from being burned in the second fuel gas supply line 41 by heating the fuel gas through the heat medium.

One end portion of the fourth diverging line 108 is connected to the exhausted fuel gas discharge line 72, and the other end portion is connected to the bath heater 96. The fourth control valve 118 is installed at the fourth diverging line 108. The fourth control valve 118 switches the circulation of the exhausted fuel gas L3 in the fourth diverging line 108 by switching the open/close, and controls the flow rate of the exhausted fuel gas L3 flowing in the fourth diverging line 108 by adjusting the degree of opening.

The fuel gas heating unit 80 heats the fuel gas L2 by burning the exhausted fuel gas L3 supplied through the fourth diverging line 108, in the bath heater 96. Accordingly, the fuel gas heating unit 80 can further increase the temperature of the fuel gas L2 to be supplied to the SOFC 13. Further, the fuel gas L2 supplied to the SOFC 13 is supplied to the gas turbine 11, as an exhausted fuel gas. Accordingly, the heat that has heated the fuel gas in the fuel gas heating unit 80 can be recovered in the gas turbine 11 or the exhausted heat recovery boiler 51. Accordingly, the calorie included in the exhausted fuel gas L3 can be effectively used. Note that the fuel gas heating unit 80 may include a path, through which the fuel gas is supplied to the bath heater 96, in addition to the path through which the exhausted fuel gas is supplied.

Further, the power generation system 10 includes an open/close valve (open/close control valve) 64 arranged in the vicinity of the gas turbine 11 of the exhausted fuel gas supply line 45 (in the present embodiment, at a downstream side of the control valve 47), a flow rate detection unit 66 that detects the flow rate of the exhausted fuel gas L3 flowing in the exhausted fuel line 43, and a state detection unit 68 that detects a state of the exhausted fuel gas L3 flowing in the exhausted fuel gas supply line 45.

The open/close valve 64 is arranged at a downstream side of the position coupled with the exhausted fuel gas discharge line 72, and at an upper stream side of the combustor 22. The open/close valve 64 can switch whether to supply the exhausted fuel gas L3 to the combustor 22 by switching the open/close.

The flow rate detection unit 66 is arranged at a downstream side of the portion coupled with the fuel gas recirculating line 49 of the exhausted fuel line 43, and at an upper stream side of the portion diverging into the discharge line 44 and the exhausted fuel gas supply line 45. The flow rate detection unit 66 is a detection device that detects the flow rate of the exhausted fuel gas L3 flowing in the exhausted fuel line 43 at the installed position. The flow rate detection unit 66 detects the pressure of the exhausted fuel gas L3 flowing in the exhausted fuel line 43, and calculates the flow rate by performing arithmetic processing with respect to a detection result of the pressure, for example. Note that, in the present embodiment, the flow rate of the exhausted fuel gas L3 flowing in the exhausted fuel line 43 is also included in the state of the exhausted fuel gas.

The state detection unit 68 is arranged at a downstream side of the blower 48 of the exhausted fuel gas supply line 45, and at an upper stream side of the position coupled with the exhausted fuel gas discharge line 72. The state detection unit 68 is a detection device that detects the calorie of the exhausted fuel gas L3 flowing in the exhausted fuel gas supply line 45 at the installed position. Note that the state detection unit 68 may just be a detection device that can detect the state of the exhausted fuel gas L3 flowing in the exhausted fuel gas supply line 45 at the installed position, and a temperature detection device that detects the temperature of the exhausted fuel gas L3 can be used, for example. Here, the state of the exhausted fuel gas L3 is various conditions by which whether a drain has occurred in the exhausted fuel gas L3 while the exhausted fuel gas L3 flows in the exhausted fuel gas supply line 45 can be determined. Note that it is favorable to arrange the state detection unit 68 at the combustor 22 side of the exhausted fuel gas supply line 45, that is, a side close to the position coupled with the exhausted fuel gas discharge line 72. Accordingly, the exhausted fuel gas supply line 45 flows, whereby change caused in the exhausted fuel gas L3 can be detected with a higher probability.

The control device (control unit) 62 of the power generation system 10 drives the heating means 70, based on at least one of the result of the flow rate detection unit 66 and the result of the state detection unit 68, after start of supply of the exhausted fuel gas L3 from the SOFC 13 to the exhausted fuel line 43, that is, after the control valve 47 is opened. Further, the control device 62 controls the open/close of the open/close valve 64, based on at least one of the result of the flow rate detection unit 66 and the result of the state detection unit 68. Accordingly, the control device 62 can switch whether to supply the exhausted fuel gas to the combustor 22.

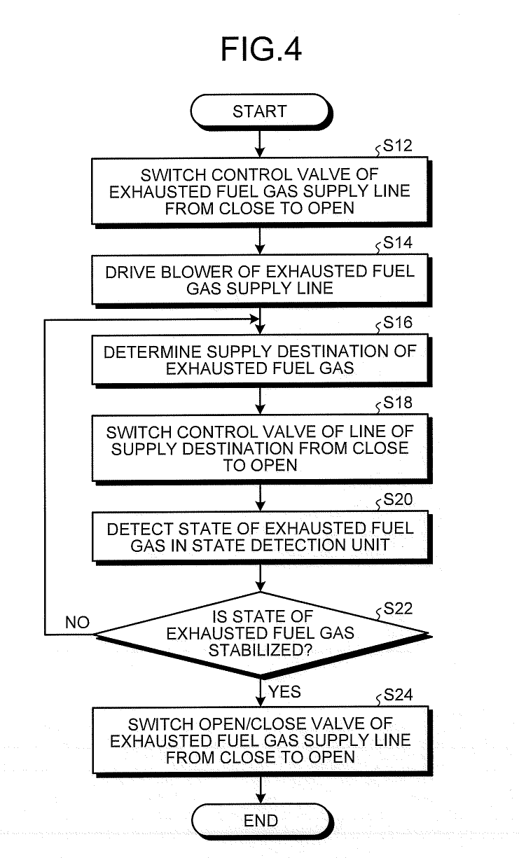

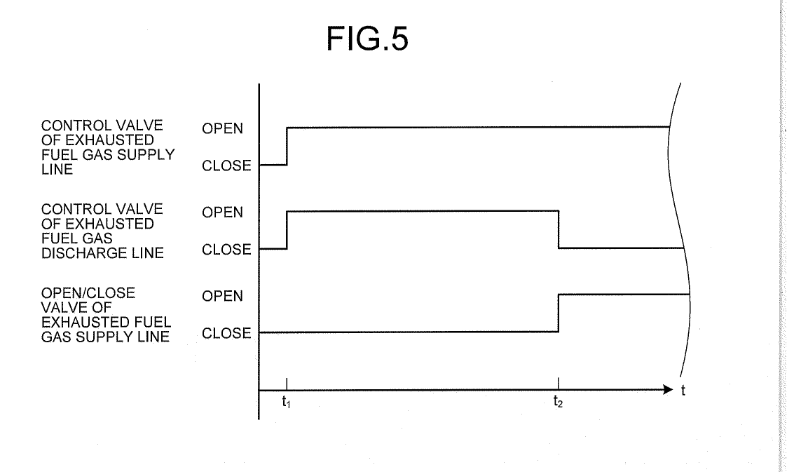

Hereinafter, a method of driving the power generation system 10 of the present embodiment will be described with reference to FIGS. 4 and 5. FIG. 4 is a flowchart illustrating an example of a drive operation of the power generation system of the present embodiment. FIG. 5 is a time chart illustrating timing of operations of valves that control a flow of an exhausted fuel gas of the power generation system of the present embodiment. The drive operation illustrated in FIG. 4 can be realized by execution of arithmetic processing by the control device (control unit) 62, based on the detection results of the units. Further, the power generation system 10 executes the circulation of the exhausted fuel gas using the fuel gas recirculating line 49 in parallel, even during the execution of the processing illustrated in FIG. 4. Here, FIG. 4 illustrates an example of control executed at the startup of the SOFC 13. As illustrated in FIG. 5, the control device 62 allows the control valve 47 of the exhausted fuel gas supply line 45, the control valve 73 of the exhausted fuel gas discharge line 72, and the open/close valve 64 of the exhausted fuel gas supply line 45 to be closed, before start of the control of FIG. 4. Here, the power generation system 10 of the present embodiment basically maintains the control valve 46 closed, and does not allow the exhausted fuel gas to be discharged trough the discharge line 44.

First, the control device 62 performs control of switching the control valve 47 of the exhausted fuel gas supply line 45 from close to open (step S12). For example, supply of the exhausted fuel gas L3 to the exhausted fuel gas supply line 45 is started by switching of the control valve 47 from close to open by the control device 62, when the exhausted fuel gas L3 is circulating in the fuel gas recirculating line 49. The control device 62 can determine the flow rate of the exhausted fuel gas L3 in the path using the detection result of the flow rate detection unit 66. Here, as illustrated by t1 of FIG. 5, the control device 62 performs control of opening the control valve 47 of the exhausted fuel gas supply line 45, and opening the control valve 73 of the exhausted fuel gas discharge line 72. Further, the control device 62 maintains the open/close valve 64 of the exhausted fuel gas supply line 45 closed. Accordingly, the exhausted fuel gas L3 is in a state of being supplied to the heating means 70.

When having started the supply of the exhausted fuel gas L3 to the exhausted fuel gas supply line 45, the control device 62 performs control of driving the blower 48 of the exhausted fuel gas supply line 45 (step S14). The blower 48 sends the exhausted fuel gas L3 flowing in the exhausted fuel gas supply line 45 toward the coupled portion with the exhausted fuel gas discharge line 72.

Next, the control device 62 determines a supply destination of the exhausted fuel gas L3 (step S16). To be specific, the control device 62 determines the supply destination of the exhausted fuel gas from among the flue gas heating unit 74, the steam generation unit 76, the air heating unit 78, and the fuel gas heating unit 80 of the heating means 70. When having determined the supply destination, the control device 62 performs control of switching the control valve of the supply destination line (diverging line) from close to open (step S18). Accordingly, the exhausted fuel gas L3 can be supplied to the determined supply destination of the heating means 70.

Next, the control device 62 detects the state of the exhausted fuel gas L3 in the state detection unit 68 (step S20), and determines whether the state of the exhausted fuel gas L3 is stabilized (step S22). That is, the control device 62 determines whether the components of the exhausted fuel gas L3 flowing in the exhausted fuel gas supply line 45 are stable. For example, when detecting the calorie of the exhausted fuel gas L3 in the state detection unit 68, the control device 62 determines that the state is stabilized when the calorie falls within a predetermined range. Further, the state detection unit 68 can measure the temperature of the exhausted fuel gas L3, as the state of the exhausted fuel gas L3. When detecting the temperature of the state detection unit 68, the control device 62 determines that the state is stabilized when the temperature becomes a fixed value or more.

When having determined that the state of the exhausted fuel gas L3 is not stabilized (No at step S22), the control device 62 returns to step S16, and re-executes the processing of step S16 again. The control device 62 repeats the processing from steps S16 to S22 while supplying the exhausted fuel gas L3 to the heating means 70 until the state of the exhausted fuel gas L3 flowing in the exhausted fuel line 43 is stabilized.

When having determined that the state of the exhausted fuel gas L3 is stabilized (Yes at step S22), the control device 62 performs control of switching the open/close valve 64 of the exhausted fuel gas supply line 45 from close to open (step S24). Here, as illustrated by t2 of FIG. 5, the control device 62 performs control of switching the control valve 73 of the exhausted fuel gas discharge line 72 from open to close while maintaining the control valve 47 of the exhausted fuel gas supply line 45 opened, and switching the open/close valve 64 of the exhausted fuel gas supply line 45 from close to open. Accordingly, the control device 62 stops the supply of the exhausted fuel gas L3 to the exhausted fuel gas discharge line 72, and starts supply of the exhausted fuel gas L3 to the combustor 22. When having started the supply of the exhausted fuel gas to the combustor 22, the control device 62 terminates the present processing.

As described above, the power generation system 10 of the present embodiment includes the heating means 70, and supplies the exhausted fuel gas L3 discharged from the SOFC 13 to the heating means 70, until the state of the exhausted fuel gas L3 is stabilized, that is, until the exhausted fuel gas L3 comes to be in a state of being suppliable to the combustor 22, at the startup of the SOFC 13 and so on. Accordingly, the exhausted fuel gas that cannot be supplied to the combustor 22 is not discharged through the discharge line 44 and can be used as a fuel of the heating means 70. Further, the heating means 70 heats the flue gas, steam, air, or fuel to be used in the power generation system 10, and thus can recover the energy that heats the objects to be heated, in the gas turbine 11 or the steam turbine 14.

Further, the power generation system 10 has the exhausted fuel gas discharge line 72 of the heating means 70 connected between the blower 48 of the exhausted fuel gas supply line 45 and the open/close valve 64, that is, with the combustor 22 side of the exhausted fuel gas supply line 45. Accordingly, in the power generation system 10, the exhausted fuel gas L3 that has reached the vicinity of the combustor 22 of the exhausted fuel gas supply line 45 is supplied to the heating means 70. Accordingly, the power generation system 10 can heat the exhausted fuel gas supply line 45 with the exhausted fuel gas until the state of the exhausted fuel gas L3 is stabilized. Further, the power generation system 10 supplies the exhausted fuel gas L3 to the heating means 70 until the exhausted fuel gas L3 that has reached the vicinity of the combustor 22 of the exhausted fuel gas supply line 45 is stabilized. Accordingly, at the startup of the SOFC 13, the exhausted fuel gas L3 flows in the exhausted fuel gas supply line 45 in a low-temperature (normal-temperature) state, and supply of the exhausted fuel gas L3 with a decreased temperature to the combustor 22 can be suppressed.

Here, a drain occurs when the exhausted fuel gas L3 is cooled. In the exhausted fuel gas L3 at the downstream side of the exhausted fuel gas supply line 45, in which the drain has occurred, the configuration of the components is changed, and the amount of water is decreased. As a result, the combustion calorific value (calorie) becomes high. Further, in the power generation system 10, the exhausted fuel gas supply line 45 is heated by the exhausted fuel gas, and thus the amount of occurrence of the drain is gradually changed. Further, following that, when the drain having occurred in the exhausted fuel gas supply line 45 is evaporated, the evaporated drain is mixed in the exhausted fuel gas L3, and H₂O of the exhausted fuel gas L3 is increased. When H₂O of the exhausted fuel gas L3 is increased, the combustion calorific value (calorie) becomes low. Accordingly, the fuel calorific value of the exhausted fuel gas L3 at the downstream side of the exhausted fuel gas supply line 45 is gradually changed. When such as exhausted fuel gas L3 is supplied to the combustor 22, the control of burning in the combustor 22 becomes complicated. Further, it is not favorable to supply the exhausted fuel gas L3, in which the drain has occurred, to the combustor 22. In response to that, the power generation system 10 of the present embodiment starts the supply of the exhausted fuel gas L3 to the combustor 22 after the state of the exhausted fuel gas L3 is stabilized at the startup of the SOFC 13. Accordingly, the power generation system 10 can suppress variation of the combustion calorific value of the exhausted fuel gas L3 to be supplied to the combustor 22. The components of the exhausted fuel gas L3 to be supplied can be stabilized, whereby the burning in the combustor 22 can be stabilized. Accordingly, the control can be simplified, and a bad influence on the gas turbine 11 can be decreased.

Further, in the power generation system 10, the exhausted fuel gas discharge line 72 is coupled with the downstream side of the blower 48 of the exhausted fuel gas supply line 45, whereby the blower 48 can be used as a drive source that supplies the exhausted fuel gas L3 to the exhausted fuel gas discharge line 72. Accordingly, one blower 48 can be effectively used.

In the power generation system 10 of the present embodiment, it is favorable to arrange the open/close valve 64 in the vicinity of the combustor 22 of the exhausted fuel gas supply line 45. That is, in the power generation system 10, it is favorable to make the distance between the open/close valve 64 and the combustor 22 short. Accordingly, when the open/close valve 64 is opened, and the supply of the exhausted fuel gas L3 to the combustor 22 is started, the range of the exhausted fuel gas supply line 45 heated by the exhausted fuel gas L3 to be supplied to the combustor 22 can be made short. Accordingly, when the supply of the exhausted fuel gas L3 to the combustor 22 is started, occurrence of the drain in the exhausted fuel gas L3 in the exhausted fuel gas supply line 45 in the range of the downstream side of the open/close valve 64 can be suppressed.

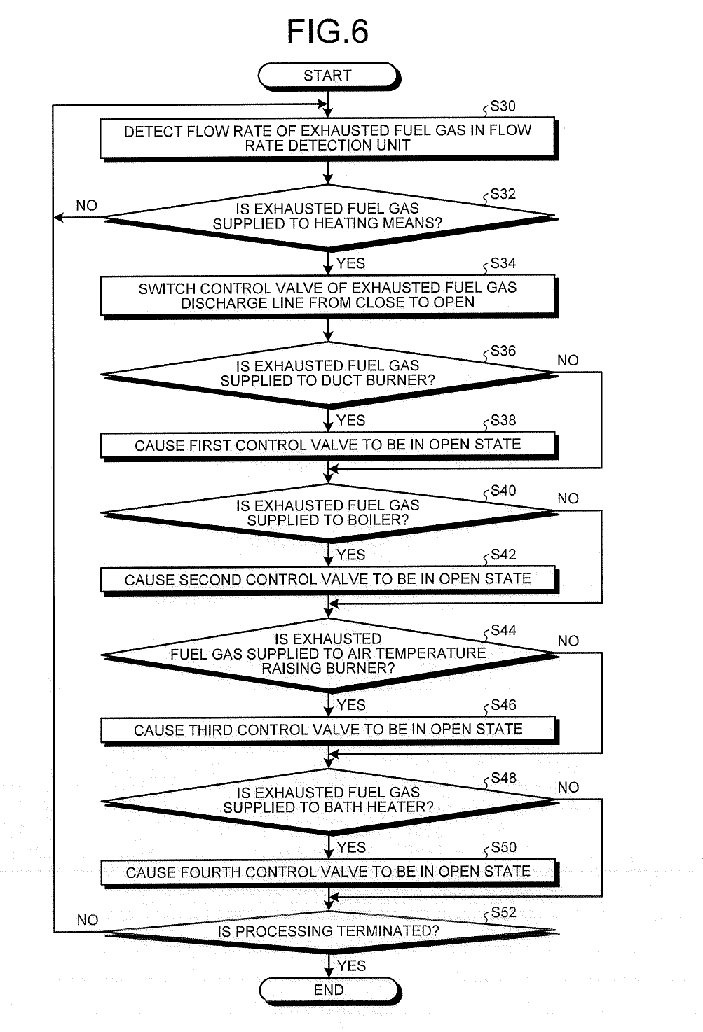

Next, a method of driving the power generation system 10 of the present embodiment will be described with reference to FIG. 6. FIG. 6 is a flowchart illustrating an example of a drive operation of the power generation system of the present embodiment. The drive operation illustrated in FIG. 6 can be realized by execution of arithmetic processing by the control device (control unit) 62, based on detection results of the units. Here, FIG. 6 is an example of control executed in a state where the exhausted fuel gas is supplied to the gas turbine. Here, in FIG. 6, processing of when the control valves are opened will be described. However, control of switching the valves from open to close and control of adjusting the degree of opening can be realized by similar processing. Further, the control of FIG. 6 can also be executed as the control of steps S16 and S18 of FIG. 4.

The control device 62 detects the flow rate of the exhausted fuel gas L3 in the flow rate detection unit 66 (step S30), and determines whether to supply the exhausted fuel gas to the heating means 70 (step S32). For example, when the flow rate detected in the flow rate detection unit 66 exceeds the flow rate of the exhausted fuel gas L3 necessary for the combustor 22 due to variation of the operation state of the gas turbine 11, the control device 62 determines to supply the exceeded amount of the exhausted fuel gas L3 to the heating means 70. When having determined not to supply the exhausted fuel gas L3 to the heating means 70 (No at step S32), that is, when having determined to supply all of the amount of the exhausted fuel gas L3 to the combustor 22, the control device 62 returns to step S30. Accordingly, the control device 62 repeats the processing of steps S30 and S32 until determining to supply the exhausted fuel gas L3 to the heating means 70.

When having determined to supply the exhausted fuel gas L3 to the heating means 70 (Yes at step S32), that is, when having determined not to supply all of the amount of the exhausted fuel gas L3 to the combustor 22, the control device 62 switches the control valve 73 of the exhausted fuel gas discharge line 72 from close to open (step S34), and determines whether to supply the exhausted fuel gas L3 to the duct burner 90 (step S36). When having determined to supply the exhausted fuel gas L3 to the duct burner 90 (Yes at step S36), the control device 62 performs control of switching the first control valve 112 from close to open (step S38).

When having determined not to supply the exhausted fuel gas L3 to the duct burner 90 (No at step S36), the control device 62 determines whether to supply the exhausted fuel gas L3 to the boiler 92 (step S40). Further, the control device 62 also determines whether to supply the exhausted fuel gas L3 to the boiler 92 when having performed control of switching the first control valve 112 from close to open (step S40). When having determined to supply the exhausted fuel gas L3 to the boiler 92 (Yes at step S40), the control device 62 performs control of switching the second control valve 114 from close to open (step S42).

When having determined not to supply the exhausted fuel gas L3 to the boiler 92 (No at step S40), the control device 62 determines whether to supply the exhausted fuel gas L3 to the air temperature raising burner (step S44). Further, the control device 62 also determines whether to supply the exhausted fuel gas L3 to the air temperature raising burner 94 when having performed control of switching the second control valve 114 from close to open (step S44). When having determined to supply the exhausted fuel gas L3 to the air temperature raising burner 94 (Yes at step S44), the control device 62 performs control of switching the third control valve 116 from close to open (step S46).

When having determined not to supply the exhausted fuel gas L3 to the air temperature raising burner 94 (No at step S44), the control device 62 determines whether to supply the exhausted fuel gas L3 to the bath heater 96 (step S48). Further, the control device 62 also determines whether to supply the exhausted fuel gas L3 to the bath heater 96 when having performed control of switching the third control valve 116 from close to open (step S48). When having determined to supply the exhausted fuel gas L3 to the bath heater 96 (Yes at step S48), the control device 62 performs control of switching the fourth control valve 118 from close to open (step S50).

When having determined not to supply the exhausted fuel gas L3 to the bath heater 96 (No at step S48), the control device 62 determines whether it is processing termination (step S52). Further, the control device 62 also determines whether it is the processing termination when having performed control of switching the fourth control valve 118 from close to open (step S52). When having determined it is not the processing termination (No at step S52), the control device 62 returns to step S30, and re-executes the above-described processing. When having determined it is the processing termination (Yes at step S52), the control device 62 terminates the present processing.

The control device 62 can effectively use the exhausted fuel gas L3 even if the exhausted fuel gas L3 not to be supplied to the combustor 22 occurs after supply of the exhausted fuel gas L3 to the gas turbine 11 is started, by performing the processing illustrated in FIG. 6. That is, the exhausted fuel gas L3 not to be supplied to the combustor 22 can be used as the fuel of the heating means 70, and the exhausted fuel gas L3 can be effectively used.

For example, the control device 62 performs control of supplying the exhausted fuel gas L3 to the boiler 92 (steam generation unit 76) at the startup of the SOFC 13, and then can perform control of supplying the exhausted fuel gas L3 to the duct burner 90 (flue gas heating unit 74). Further, when the SOFC 13 in operation trips, the control device 62 performs control of supplying the exhausted fuel gas L3 to the duct burner 90 (flue gas heating unit 74).

Note that the processing illustrated in FIG. 6 is processing to execute determination of steps S36, S40, S44, and S48 regardless of the result of open/close so that the supply of the exhausted fuel gas L3 to the plurality of units: the duct burner 90, the boiler 92, the air temperature raising burner 94, and the bath heater 96 can be started. However, the processing is not limited thereto. For example, the control device 62 may proceed in the determination of step S52 after performing the processing of steps S38, S42, S46, and S50.

Here, as the mechanisms of the heating means 70 of the present embodiment to heat the exhausted fuel gas, the four mechanism of the flue gas heating unit 74, the steam generation unit 76, the air heating unit 78, and the fuel gas heating unit 80 have been provided. However, at least one mechanism may just be provided. Further, the mechanisms to burn the exhausted fuel gas, which is included in the heating means 70, are not limited to the above-described four mechanisms, and any mechanism may be employed as long as the mechanism can be used for, the power generation system 10 other than the gas turbine 11.

Here, the heating means 70 of the present embodiment can use the units of the heating means 70 even when not supplying the exhausted fuel gas, by including a path, through which the fuel gas is supplied to a region where the exhausted fuel gas is burned. Accordingly, the heating means 70 can use the exhausted fuel gas as a supplemental fuel, and thus can be always operated. Therefore, the units of the heating means 70 can be efficiently used.

To be specific, the control device 62 can adjust balance among the exhausted fuel gas L3, the fuel gases L4, L5, and L6 to be supplied to the units of the heating means 70 by performing the control of the control valves 132, 134, and 138, together with the control of the first control valve 112, the second control valve 114, the third control valve 116, and the fourth control valve 118. For example, the control device 62 can control the amount of combustion and the calorific value generated in the duct burner 90 by adjusting balance between the degree of opening of the first control valve 112 and the degree of opening of the control valve 132. Accordingly, the control device 62 can control a ratio of the amount of generation of the steam in the gas turbine 11 and the output of the power generation of the generator 15. Further, the power generation system 10 can efficiently use the units of the heating means 70, and thus it is favorable to provide a path, through which the fuel gas is supplied, in addition to the paths through which the exhausted fuel gasses are supplied to the units of the heating means 70 like the present embodiment. However, such a path is not necessarily provided.

Here, the power generation system 10 of the present embodiment can switch whether to supply the exhausted fuel gas L3 to the range where the blower 48 and the state detection unit 68 of the exhausted fuel gas supply line 45 are arranged by including the control valve 47 at the upper stream side of the blower 48 and the state detection unit 68 of the exhausted fuel gas supply line 45. Further, in FIG. 2, the position of the control valve 47 is the position arranged at the combustor 22 side of the exhausted fuel gas supply line 45. However, the arranged position is not especially limited, and may just be the position at the downstream side of the coupled portion with the discharge line 44, and at the upper stream side of the coupled portion with the exhausted fuel gas discharge line 72.

Since the power generation system 10 of the present embodiment can heat the exhausted fuel gas supply line 45, it is favorable to connect the exhausted fuel gas discharge line 72 of the heating means 70 with the gas turbine 11 side of the exhausted fuel gas supply line 45. However, the connection is not limited thereto. In the power generation system 10, the exhausted fuel gas discharge line 72 may be connected to the exhausted fuel line 43, or may be connected to the discharge line 44. Note that the power generation system 10 of the present embodiment can discharge the exhausted fuel gas to the exhausted fuel gas discharge line 72, in place of discharging the exhausted fuel gas through the discharge line 44. Therefore, the discharge line 44 and the control valve 46 may not be provided. That is, the power generation system 10 may include the exhausted fuel gas discharge line 72 in place of the discharge line 44.

Further, the power generation system 10 of the present embodiment may include a drain recovery mechanism that recovers the drain from the exhausted fuel gas L3, at the exhausted fuel gas discharge line 72. As the drain recovery mechanism, for example, a mechanism to cool the exhausted fuel gas L3 and a mechanism (trap) to collect the drain are included. As the drain recovery mechanism, the drain recovery mechanism may cool the exhausted fuel gas L3 by heat exchange using a reheat exchanger and recovers the drain, and then performs reheat with the heat recovered from the exhausted fuel gas L3 before the drain recovery.

Further, the power generation system 10 of the present embodiment includes the control valve 73, and switches whether to supply the exhausted fuel gas to the exhausted fuel gas discharge line 72. However, the control valve 73 is not necessarily provided because whether to supply the exhausted fuel gas can be switched in each of the first control valve 112, the second control valve 114, the third control valve 116, and the fourth control valve 118.

The open/close valve 64 that adjusts the supply of the fuel gas to the combustor 22 may at least be able to switch the open/close, and may be a control valve that adjusts the degree of opening. Further, the control valve 47 arranged at the upper stream side of the blower 48 of the exhausted fuel gas supply line 45 may at least be able to switch the open/close, and may be an open/close valve. Similarly, at least one of the control valve 47 and the open/close valve 64 provided at the exhausted fuel gas supply line 45 is favorably a control valve that can adjust the degree of opening (passage resistance). Accordingly, the amount of the exhausted fuel gas to be supplied to the combustor 22 can be adjusted. Note that the power generation system 10 can control the supply of the exhausted fuel gas to the exhausted fuel gas supply line 45 by controlling the open/close of the open/close valve 64 and the control valve 73. Therefore, the control valve 47 may not be provided.

### REFERENCE SIGNS LIST

10 POWER GENERATION SYSTEM
11 GAS TURBINE
12 GENERATOR
13 SOLID OXIDE FUEL CELL (SOFC)
14 STEAM TURBINE
15 GENERATOR
21 COMPRESSOR
22 COMBUSTOR
23 TURBINE
25 AIR TAKING-IN LINE
26 FIRST COMPRESSED AIR SUPPLY LINE
27 FIRST FUEL GAS SUPPLY LINE
31 SECOND COMPRESSED AIR SUPPLY LINE
32 CONTROL VALVE (FIRST OPEN/CLOSE VALVE)
33 and 48 BLOWER
34 EXHAUSTED AIR LINE
36 COMPRESSED AIR CIRCULATING LINE
41 SECOND FUEL GAS SUPPLY LINE
42 CONTROL VALVE
43 EXHAUSTED FUEL LINE
44 DISCHARGE LINE
45 EXHAUSTED FUEL GAS SUPPLY LINE
47 CONTROL VALVE
49 FUEL GAS RECIRCULATING LINE
50 RECIRCULATING BLOWER
51 EXHAUSTED HEAT RECOVERY BOILER
52 TURBINE
53 FLUE GAS LINE
54 STEAM SUPPLY LINE
55 FEED WATER LINE
56 CONDENSER
57 FEED WATER PUMP
62 CONTROL DEVICE (CONTROL UNIT)
64 OPEN/CLOSE VALVE
66 FLOW RATE DETECTION UNIT
68 STATE DETECTION UNIT
70 HEATING MEANS
72 EXHAUSTED FUEL GAS DISCHARGE LINE
73 CONTROL VALVE
74 FLUE GAS HEATING UNIT
76 STEAM GENERATION UNIT
78 AIR HEATING UNIT
80 FUEL GAS HEATING UNIT
90 DUCT BURNER
92 BOILER
94 AIR TEMPERATURE RAISING BURNER
96 BATH HEATER
102 FIRST DIVERGING LINE
104 SECOND DIVERGING LINE
106 THIRD DIVERGING LINE
108 FOURTH DIVERGING LINE
112 FIRST CONTROL VALVE
114 SECOND CONTROL VALVE
116 THIRD CONTROL VALVE
118 FOURTH CONTROL VALVE
122 THIRD FUEL GAS SUPPLY LINE
124 FOURTH FUEL GAS SUPPLY LINE
125 AIR SUPPLY LINE
128 FIFTH FUEL GAS SUPPLY LINE
132, 134, 135, and 138 CONTROL VALVE

1. A power generation system comprising:
a gas turbine including a compressor and a combustor;
a fuel cell;
an exhausted fuel gas supply line configured to supply an exhausted fuel gas discharged from the fuel cell to the gas turbine;
an exhausted fuel gas discharge line connected to the exhausted fuel gas supply line;
a heating unit configured to burn the exhausted fuel gas supplied through the exhausted fuel gas discharge line to heat an object to be heated; and
a control unit configured to control a supply destination of the exhausted fuel gas discharged from the fuel cell.

2. The power generation system according to claim 1, further comprising:
a heat exchanger configured to recover heat included in a flue gas discharged from the gas turbine, wherein
the heating unit includes a flue gas heating unit that burns the exhausted fuel gas to heat the flue gas to be supplied to the heat exchanger.

3. The power generation system according to claim 1, wherein the heating unit includes a steam generation unit that burns the exhausted fuel gas to generate steam to be supplied to a fuel gas to be supplied to the fuel cell.

4. The power generation system according to claim 1, wherein the heating unit includes an air heating unit that burns the exhausted fuel gas to heat air to be supplied to the fuel cell.

5. The power generation system according to claim 1, wherein the heating unit includes a fuel gas heating unit that burns the exhausted fuel gas to heat a fuel gas to be supplied to the fuel cell.

6. The power generation system according to claim 1, comprising:
a state detection unit configured to detect a state of the exhausted fuel gas at an upper stream side of the exhausted fuel gas discharge line, wherein
when it is determined that the state of the exhausted fuel gas is stabilized, based on a result detected in the state detection unit, supply of the exhausted fuel gas to the gas turbine is started.

7. The power generation system according to claim 1, comprising:
a flow rate detection unit configured to detect a flow rate of the exhausted fuel gas to be supplied from the fuel cell to the exhausted fuel gas supply line and the exhausted fuel gas discharge line, wherein
the control unit controls a flow rate of the exhausted fuel gas to be supplied to the exhausted fuel gas supply line and a flow rate of the exhausted fuel gas to be supplied to the exhausted fuel gas discharge line, based on a detection result of the flow rate detection unit.

8. A method of operating a power generation system including a gas turbine including a compressor and a combustor, a fuel cell, and heating unit that burns an exhausted fuel gas to heat an object to be heated, the method comprising:
detecting a state of the exhausted fuel gas discharged from the fuel cell toward the gas turbine;
determining whether there is the exhausted fuel gas not to be supplied to the gas turbine, based on the detected state of the exhausted fuel gas; and
supplying the exhausted fuel gas to the heating unit when it is determined that there is the exhausted fuel gas not to be supplied to the gas turbine.
